(19) United States
(12) Patent Application Publication
(10) Pub. No.: US 2009/0303151 A1
(43) Pub. Date: Dec. 10, 2009

(54) LOW PROFILE GPS ANTENNA ASSEMBLY

(75) Inventors: Lung-Sheng Tai, Tu-Cheng (TW); Wen-Fong Su, Tu-Cheng (TW); Shang-Jen Chen, Tu-Cheng (TW); Chun-Ming Chiu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/481,599

(22) Filed: Jun. 10, 2009

(30) Foreign Application Priority Data
Jun. 10, 2008 (TW) 97121502

(51) Int. Cl. H01Q 1/38; H01Q 1/12

(52) U.S. Cl. 343/878; 343/700 MS

(57) ABSTRACT

An antenna assembly includes a printed circuit board with a first surface and a second surface, a support attached on the first surface of the printed circuit board, and an antenna attached on the support. The printed circuit board includes a fastening area located on the first surface thereof, and a plurality of electric circuit arranged on the first surface of the printed circuit board. The support includes a receiving space corresponding to the fastening area of the printed circuit board. The antenna includes a planar radiating element substantially arranged on a first plane, and a connecting element being located on a second plane perpendicular to the first plane and extending downwardly from one edge of the radiating element. The connecting element includes an L-shaped connecting arm connected to the radiating element, at least one connecting pad and at least one grounding pad respectively extending from the connecting arm.

### BACKGROUND OF THE INVENTION

1. Field of the Invention

The present invention relates generally to a Global Positioning System (GPS) antenna assembly, and more particularly to an antenna assembly for building into an electronic device, such as a notebook, PDA et al..

2. Description of the Prior Art

At present, GPS has been widely built in electronic devices, such as notebooks, PDAs et al. for convenience in view of its exactly positioning ability and navigational function. In order for the GPS being functionally worked with the devices, an antenna, a necessary component for wireless communication, betook for GPS are need to be assembled with these electronic devices.

Conventional GPS antennas typically include ceramic attached with PCBs. Taiwanese Patent No. 559348, issued to Teng, Cheng-Ming on Nov. 21, 2003, discloses a GPS antenna assembly including a printed circuit board (PCB), a ceramic antenna attached on one surface of the PCB, and a Low Noise Amplifier (LNA) attached on the other surface of the PCB. The ceramic antenna and the LNA are respectively arranged on the two surface of the PCB as to increase the height of the antenna assembly.

Hence, in this art, a GPS antenna assembly to overcome the above-mentioned disadvantages of the prior art should be provided.

### BRIEF SUMMARY OF THE INVENTION

A primary object, therefore, of the present invention is to provide a antenna assembly with simple structure and ultra wide band.

In order to implement the above object, the antenna assembly comprises an printed circuit board with a first surface and a second surface, a support attached on the first surface of the printed circuit board, and an antenna attached on the support. The printed circuit board comprises a fastening area located on the first surface thereof, and a plurality of electric circuit arranged on the first surface of the printed circuit board. The support comprises a receiving space corresponding to the fastening area of the printed circuit board. The antenna comprises a planar radiating element substantially arranged on a first plane, and a connecting element being located on a second plane perpendicular to the first plane and extending downwardly from one edge of the radiating element. The connecting element comprises an L-shaped connecting arm connected to the radiating element, at least one connecting pad and at least one grounding pad respectively extending from the connecting arm.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a preferred embodiment of an antenna assembly in according with the present invention;

FIG. 2 is an exploded, perspective view of FIG. 1; and

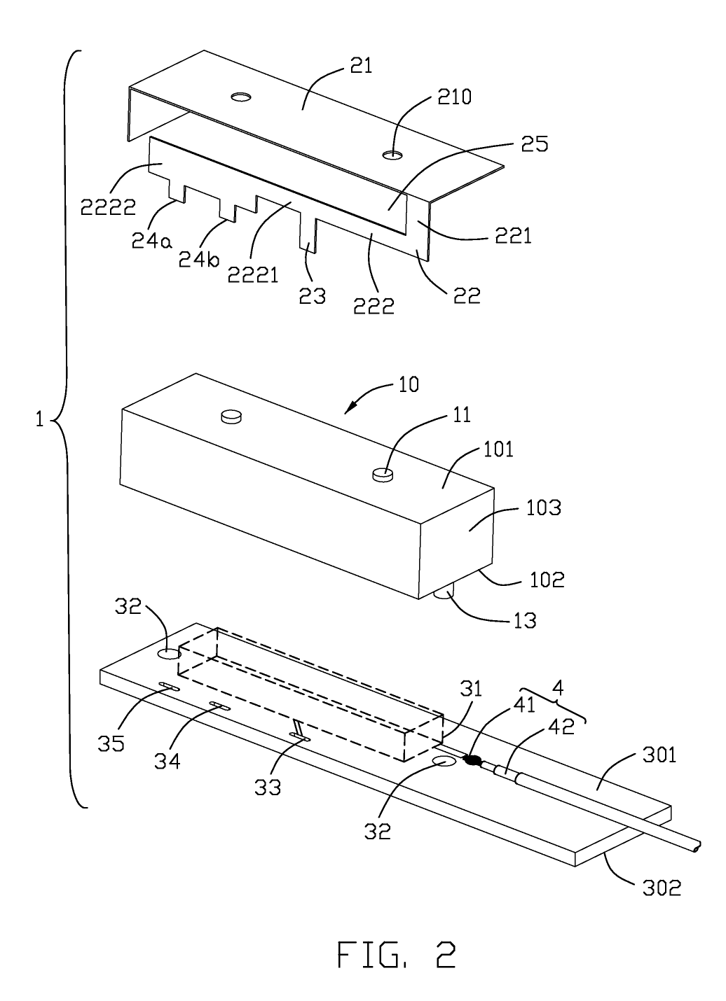

FIG. 3 is an exploded, perspective view similar to FIG, 2, but viewed from another angle.

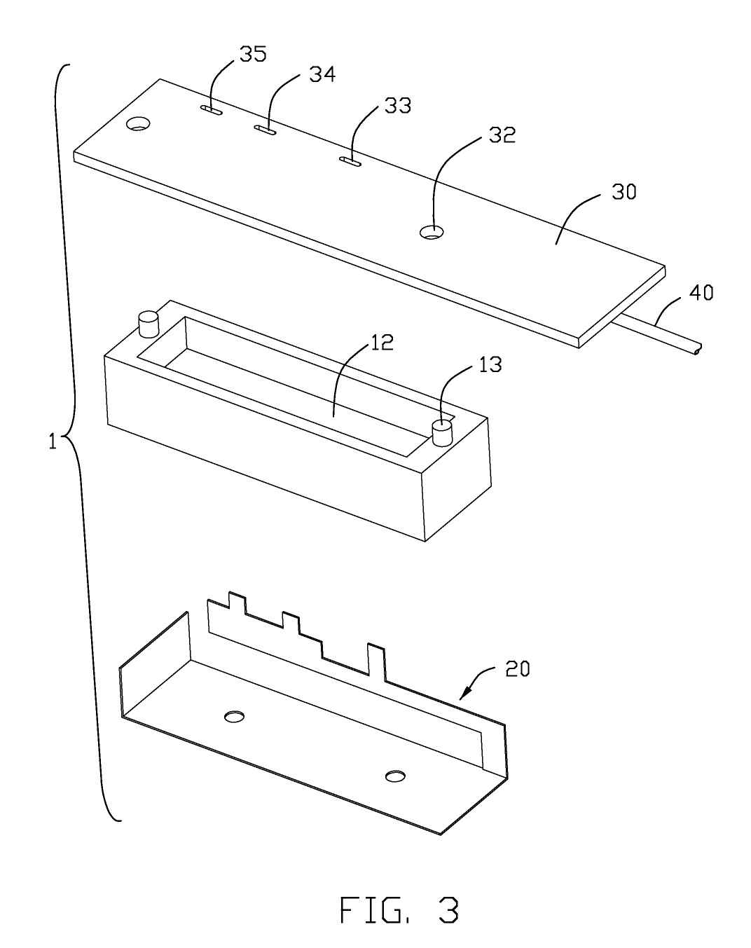

### DETAILED DESCRIPTION OF THE INVENTION

Reference will now be made in detail to a preferred embodiment of the present invention.

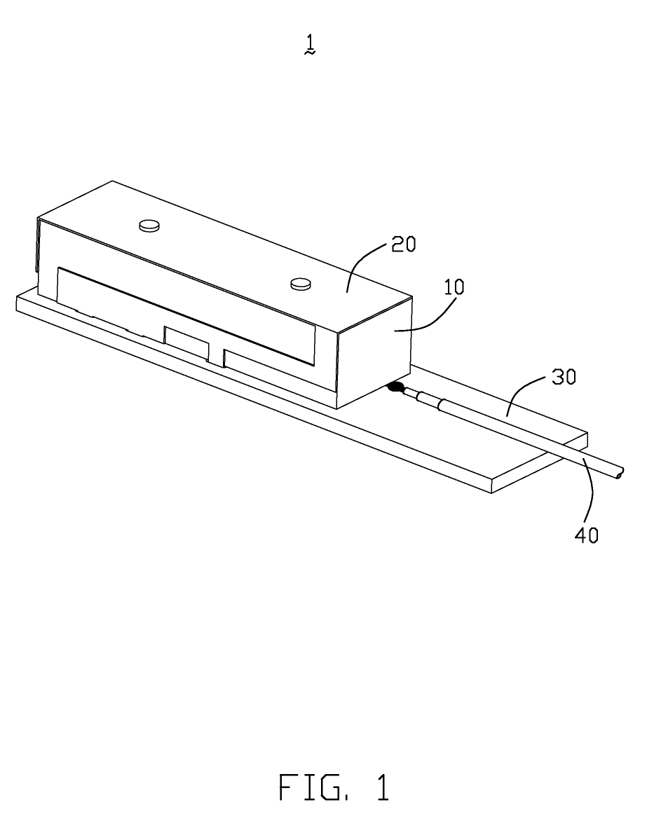

Reference to FIG. 1, a antenna assembly 1 in according with a preferred embodiment of the present invention is shown. The antenna assembly 1 comprises a printed circuit board (PCB) 30, a support 10 attached on one surface of the PCB 30, an antenna 20 attached on the support 10, and a feeding line 40 connected to the PCB 30.

The support 10 is of cuboid configuration and has an upper surface 101, a lower surface 102 opposite to the first surface 101, and four side surfaces 103 connecting the upper surface 101 and the lower surface 102. A pair of poles 11 extends from the upper surface of the support 10 and is arranged on the central axes of the upper surface of the support 10. A receiving space 12 is formed in the support 10 by inwardly depressed from the lower surface 102 of the support 10. A pair of fastening posts 13 extends downwardly from the lower surface 102 and is respectively arranged on the two sides of the receiving space 12.

The antenna 20 is a planar inverted-F antenna, and respectively arranged on three of the six surfaces of the support 10. The antenna 20 comprises a radiating element 21, a connecting element 22 extending downwardly from the radiating element 21, a connecting pad 23, and a pair of grounding pads 24, 25. The radiating element 21 is substantially parallel to the PCB 30 and of L shape for its end bent downwardly. The radiating element 21 is respectively arranged on the upper surface 101 and one of the side surfaces 103. A pair of holes 210 is formed on the radiating element 21 as to correspond to the pair of poles 11 of the support 10. When the antenna 10 is assembled on the support 10, the poles 11 of the support 10 can respectively extend through the holes 210 of the antenna 10. The connecting element 22 is located on one of the side surfaces 103 which is adjacent to the side surface 103 attached by the radiating element 21. The connecting element 22 includes a first connecting arm 221 extending downwardly from the radiating element 21 along a perpendicular direction to the radiating element 21, and a second connecting arm 222 extending from the first connecting arm 221 along a perpendicular direction to the first connecting arm 221. A slot 25 is formed between the radiating element 21 and the second connecting arm 222. The second connecting arm 222 includes a first section 2221 connected to the first connecting arm 221 and a second section 2222 wider than the first section 2221 and extending from the first section 2221. The connecting pad 23 extends downwardly from the first section 2221 of the connecting element 22 and the pair of grounding pads 24, 25 extends from the second section 2222 of the connecting element 22.

The PCB 30 has a first surface 301 and a second surface 302. The support 10 with the antenna 20 is attached on the first surface 301 of the PCB 30. A pair of holes 32 is formed on the first surface 301 and respectively corresponds to the fastening posts 13 of the support 10. A first, second and third slot 33, 34, 35, which are spaced apart from each other, connect the first surface 301 to the second surface 302 and respectively corresponds to the three pads 23, 24a, 24b. A fastening area 31 is defined between the two holes 32 so as to make the slots 33, 34, 35 located on one side of the fastening area 31. In assembling, the fastening posts 13 are inserted into the holes 32 of the PCB 30 as to make the support 10 securely fastened on the PCB 30. The three pads 23, 24a, 24b are respectively inserted into the slots 33, 34, 35 and soldered on the PCB 30. There is a plurality of electric circuits arranged on the PCB 30. A Low Noise Amplifier (LNA) (not shown) is arranged on the fastening area 31 and received in the receiving space 12 of the support 10 as to be connected to a part of the electric circuits. The slot 33 is electrically connected to the LNA. The slots 34, 35 are both electrically connected to another part of the electrical circuit which can be used as a grounding element.

The feeding line 40 is arranged on the first surface 301 of the PCB 30 and includes an inner conductor 41 and an outer conductor 42. The inner conductor 41 is electrically connected to the LNA so as to feed electric current into the antenna 20 through the LNA. The outer conductor 42 is electrically connected to the electric circuit of the PCB which is electrically connected to the grounding pads 24a, 24b.

In this embodiment, the support 10 is made from plastic but not ceramic which own specifically permittivity. Thus, that the LNA is received in the receiving space 12 of the support 10 will not influent the performance of the antenna 20. While the structure can make the antenna assembly featured with a compact height. In this embodiment, the antenna 20 is a GPS antenna which operates at 1.5GHz frequency. In other embodiments, the antenna 10 can be design to work at other frequencies, and the support can be made from other insulating material. It might also be noted that the material of the support must fit the antenna.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna assembly, comprising:
a printed circuit board with a first surface and a second surface, comprising a fastening area located on the first surface thereof, and a plurality of electric circuit arranged on the first surface of the printed circuit board;
a support, attached on the first surface of the printed circuit board and comprising a receiving space corresponding to the fastening area of the printed circuit board; and
an antenna, attached on the support and comprising a planar radiating element substantially arranged on a first plane, and a connecting element being located on a second plane perpendicular to the first plane and extending downwardly from one edge of the radiating element;
said connecting element comprising an L-shaped connecting arm connected to the radiating element, at least one connecting pad and at least one grounding pad respectively extending from the connecting arm.

2. The antenna assembly as claimed in claim 1, wherein said printed circuit board further comprises a pair of holes located on the two sides of the fastening area and connecting the first surface and the second surface thereof, and a plurality of slots spaced apart from the fastening area and connecting the first surface and the second surface thereof.

3. The antenna assembly as claimed in claim 2, wherein said support comprises a pair of fastening poles corresponding to the pair of holes.

4. The antenna assembly as claimed in claim 2, wherein said connecting pads are corresponding to the slots of the printed circuit board and respectively electrically connected to their corresponding slots.

5. The antenna assembly as claimed in claim 1, wherein said antenna assembly further comprises a low noise amplifier attached on the fastening area of the printed circuit board.

6. The antenna assembly as claimed in claim 5, wherein said low noise amplifier is received in the receiving space of the support.

7. The antenna assembly as claimed in claim 1, wherein said radiating element is of L configuration, and has an end bent downwardly.

8. The antenna assembly as claimed in claim 7, wherein said end of the radiating element is located on a third plane perpendicular to the first plane and the second plane.

9. An antenna assembly, comprising:
a printed circuit board with a first surface and a second surface, comprising a fastening area located on the first surface thereof, and a plurality of electric circuit arranged on the first surface of the printed circuit board;
a support, attached on the first surface of the printed circuit board and comprising a receiving space corresponding to the fastening area of the printed circuit board; and
an antenna, attached on the support and used for GPS net;
a low noise amplifier, attached on the fastening area of the printed circuit board and received in the receiving space of the support.

10. The antenna assembly as claimed in claim 9, wherein said antenna comprises a planar radiating element substantially arranged on a first plane, and a connecting element being located on a second plane perpendicular to the first plane and extending downwardly from one edge of the radiating element, said connecting element comprising an L-shaped connecting arm connected to the radiating element, at least one connecting pad and at least one grounding pad respectively extending from the connecting arm.

11. The antenna assembly as claimed in claim 10, wherein said printed circuit board further comprises a pair of holes located on the two sides of the fastening area and connecting the first surface and the second surface thereof, and a plurality of slots spaced apart from the fastening area and connecting the first surface and the second surface thereof.

12. The antenna assembly as claimed in claim 11, wherein said support comprises a pair of fastening poles corresponding to the pair of holes, said connecting pads are corresponding to the slots of the printed circuit board and respectively electrically connected to their corresponding slots.

13. The antenna assembly as claimed in claim 10, wherein said radiating element is of L configuration, and has an end bent downwardly.

14. The antenna assembly as claimed in claim 13, wherein said end of the radiating element is located on a third plane perpendicular to the first plane and the second plane.

15. An antenna assembly comprising:
a printed circuit board defining a mounting area;
an insulative support mounted upon the mounting area;
an antenna assembled upon an exterior face of the support and including a radiating element, and a connecting element unitarily extending from the radiating element and mechanically and electrically connected to a grounding circuit of the printed circuit board; wherein the support defines a downward space downwardly communicating with the printed circuit board to receive at least one electronic component mounted upon the printed circuit board.

16. The antenna assembly as claimed in claim 15, wherein the connecting element is further electrically connected to the electronic component via traces so as to affect the radiating element.

17. The antenna assembly as claimed in claim 15, further including a feeder cable defining an inner conductor electrically connected to the electronic component via traces, and an outer conductor electrically connected to the grounding circuit.

18. The antenna assembly as claimed in claim 15, wherein said electronic component is fully protectively shielded within the receiving space without exposure to an exterior.

19. The antenna assembly as claimed in claim 15, wherein the radiating element is located upon a top face of the support while the connecting element is located on a side face of the support.
